(19) United States
(12) Patent Application Publication
(10) Pub. No.: US 2015/0109315 A1
(43) Pub. Date: Apr. 23, 2015

(54) SYSTEM, METHOD, AND COMPUTER PROGRAM PRODUCT FOR MAPPING TILES TO PHYSICAL MEMORY LOCATIONS

(71) Applicant: NVIDIA Corporation, Santa Clara, CA (US)

(72) Inventors: Amanpreet Grewal, Lancaster, NY (US); Andrei Khodakovsky, Belmont, CA (US); Yu Denny Dong, San Jose, CA (US); Henry Packard Moreton, Woodside, CA (US); Naveen Leekha, Cary, NC (US)

(73) Assignee: NVIDIA Corporation, Santa Clara, CA (US)

(21) Appl. No.: 14/061,693

(22) Filed: Oct. 23, 2013

(51) Int. Cl. G06T 1/60; G06F 12/10

(52) U.S. Cl. CPC G06T 1/60; G06F 12/1009
USPC 345/552

(57) ABSTRACT

A system, method, and computer program product are provided for mapping tiles to physical memory locations. In use, a plurality of virtual tiles associated with a texture is identified. Additionally, a request to perform a mapping of the plurality of virtual tiles to one or more physical memory locations is received. Further, the plurality of virtual tiles is mapped to the one or more physical memory locations, utilizing a page table.

### FIELD OF THE INVENTION

The present invention relates to rendering graphical objects, and more particularly to associating graphics resources to memory.

### BACKGROUND

Traditionally, virtual memory allocation management has been used to provide graphics processing units (CPUs) with virtual memory. For example, a one-to-one mapping between virtual and physical pages has been used to enable virtual memory. However, current techniques for implementing this mapping have been associated with various limitations.

For example, a need has arisen for a more flexible association of graphics resources to memory. This new implementation necessitates the ability to freely associate virtual addresses of a resource to arbitrary regions of an existing physical memory allocation. There is thus a need for addressing these and/or other issues associated with the prior art.

### SUMMARY

A system, method, and computer program product are provided for mapping tiles to physical memory locations. In use, a plurality of virtual tiles associated with a texture is identified. Additionally, a request to perform a mapping of the plurality of virtual tiles to one or more physical memory locations is received. Further, the plurality of virtual tiles is mapped to the one or more physical memory locations, utilizing a page table.

### BRIEF DESCRIPTION OF THE DRAWINGS

FIG. 1 shows a method for mapping tiles to physical memory locations, in accordance with one embodiment.

FIG. 2 shows an exemplary flexible mapping configuration, in accordance with another embodiment.

FIG. 3 shows a method for updating mappings using a CPU driven solution, in accordance with another embodiment.

FIG. 4 shows a method for responding to a location eviction or movement using a CPU driven solution, in accordance with another embodiment

FIG. 5 illustrates an exemplary system in which the various architecture and/or functionality of the various previous embodiments may be implemented.

### DETAILED DESCRIPTION

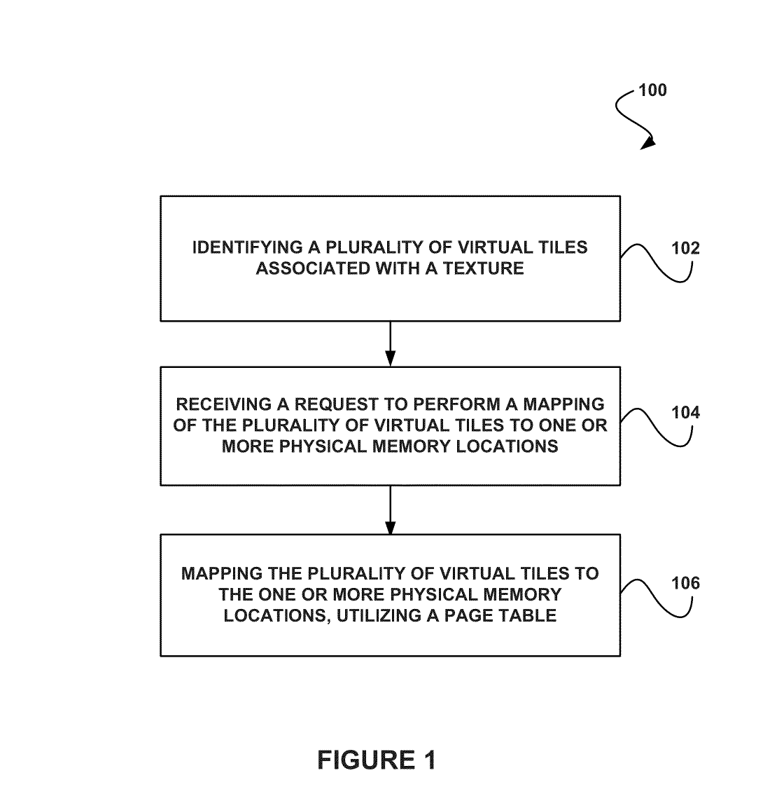

FIG. 1 shows a method 100 for mapping tiles to physical memory locations, in accordance with one embodiment. As shown in operation 102, a plurality of virtual tiles associated with a texture is identified. In one embodiment, the texture may include a portion of a graphical scene to be displayed and/or rendered. In another embodiment, the texture may be associated with the surface of one or more objects within a graphical scene. For example, the texture may indicate the characteristics of one or more surfaces of one or more objects.

Additionally, in one embodiment, the plurality of virtual tiles may be included within the texture. For example, the texture may be divided up into the plurality of virtual tiles, such that each of the plurality of tiles includes a portion of the total texture. In another embodiment, the virtual tiles may be arranged in a grid. For example, the texture may be broken up into discrete virtual tiles in a regular grid (e.g., for two dimensional (2D)) textures, etc.). In yet another embodiment, the plurality of virtual tiles may be identified by an application (e.g., a graphics display application, etc.).

Further, as shown in operation 104, a request to perform a mapping of the plurality of virtual tiles to one or more physical memory locations is received. In one embodiment, the request to perform the mapping may be received from an application (e.g., a graphics application, etc.). In another embodiment, the one or more physical memory locations may include one or more physical pages in memory (e.g., random access memory (RAM), read-only memory (ROM), etc.). In yet another embodiment, each of the one or more physical memory locations may store data (e.g., data for one or more virtual tiles, etc.).

Further still, in one embodiment, the request may include one or more commands. For example, the request may include one or more application commands to be executed. In another embodiment, the one or more commands may be queued. In yet another embodiment, the request may be received by a user mode component. For example, the request may be received by a user mode driver (UMD).

Also, in one embodiment, the request may include one or more parameters. For example, the request may include a defined virtual address space (e.g., a space where one or more of the virtual memory locations are located, etc.). In another example, the request may include the coordinates of a grid. In yet another example, the request may include one or more addresses of the physical memory locations (e.g., a range of the locations, the specific addresses of the one or more physical memory locations, etc.).

In addition, in one embodiment, the request may indicate that multiple virtual tiles map to a single physical memory location. In another embodiment, the request may indicate that a virtual tile does not map to a physical memory location. In yet another embodiment, the request may indicate that a virtual tile maps to a physical memory location that is grouped separately from (e.g., that is within a different range than) the other physical memory locations that are mapped to other virtual tiles within the texture.

Furthermore, as shown in operation 106, the plurality of virtual tiles is mapped to the one or more physical memory locations, utilizing a page table. In one embodiment, mapping the plurality of tiles to the one or more physical memory locations may include passing the request to perform the mapping to a kernel mode component. For example, the request may be passed from the UMD to a kernel mode driver (KMD). In another embodiment, the mapping of the plurality of tiles to the one or more physical memory locations may be performed by the KMD.

Further still, in one embodiment, the page table may store the mapping between one or more virtual addresses and one or more physical addresses. For example, the page table may store the mapping between one or more virtual addresses, where each virtual address represents a tile, and one or more physical addresses, where each physical address represents a physical memory location. In another embodiment, the page table may include a plurality of entries. For example, each page table entry in the page table may reference a particular virtual tile as well as a physical address for the physical memory location where the data for the virtual tile resides.

Also, in one embodiment, the mapping between one or more virtual addresses and one or more physical addresses may not he contiguous or continuous within the page table. For example, adjacent virtual tiles may not be mapped to adjacent physical memory locations within the page table. In another embodiment, the mapping between the plurality of virtual tiles and the one or more physical memory locations may be managed using one or more solutions.

Additionally, in one embodiment, the mapping may be managed using a central processing unit (CPU)-driven solution. In one embodiment, a request to change one or more mappings within the page table may be received from an application. For example, the request may be received by the UMD. In another embodiment, the UMD may forward the request to the KMD. In yet another embodiment, the KMD may update the page table to reflect the requested changes.

Furthermore, in one embodiment, the location of one or more physical memory locations may be moved or evicted (e.g., by an operating system, etc.), where the one or more physical memory locations are each mapped to one or more virtual tiles within the page table. In another embodiment, the KMD may update the page table to reflect the moving and/or eviction of the one or more physical memory locations.

Further still, in another embodiment, the mapping may be managed using a graphics processing unit (GPU)-driven solution. For example, the GPU may write to the page table using a compute shader invocation that is controlled and initiated by the KMD. For example, the KMD may feed validation parameters into the compute shader. In another example, the compute shader invocation may be interleaved and serialized with one or more additional application initiated rendering operations.

Also, in one embodiment, the location of one or more physical memory locations may be moved or evicted (e.g., by an operating system, etc.), where the one or more physical memory locations are each mapped to one or more virtual tiles within the page table. In another embodiment, the GPU may scan the page table entries associated with the virtual tiles and may determine whether any of the page table entries for a virtual tile reference a physical memory location that is being moved or evicted. In yet another embodiment, if it determined that a page table entry for a virtual tile references a physical memory location that is being moved to a new location, then the address of the new location may be updated within the page table. In still another embodiment, if it determined that a page table entry for a virtual tile references a physical memory location that is evicted, then the address of the location may be set to invalid within the page table.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

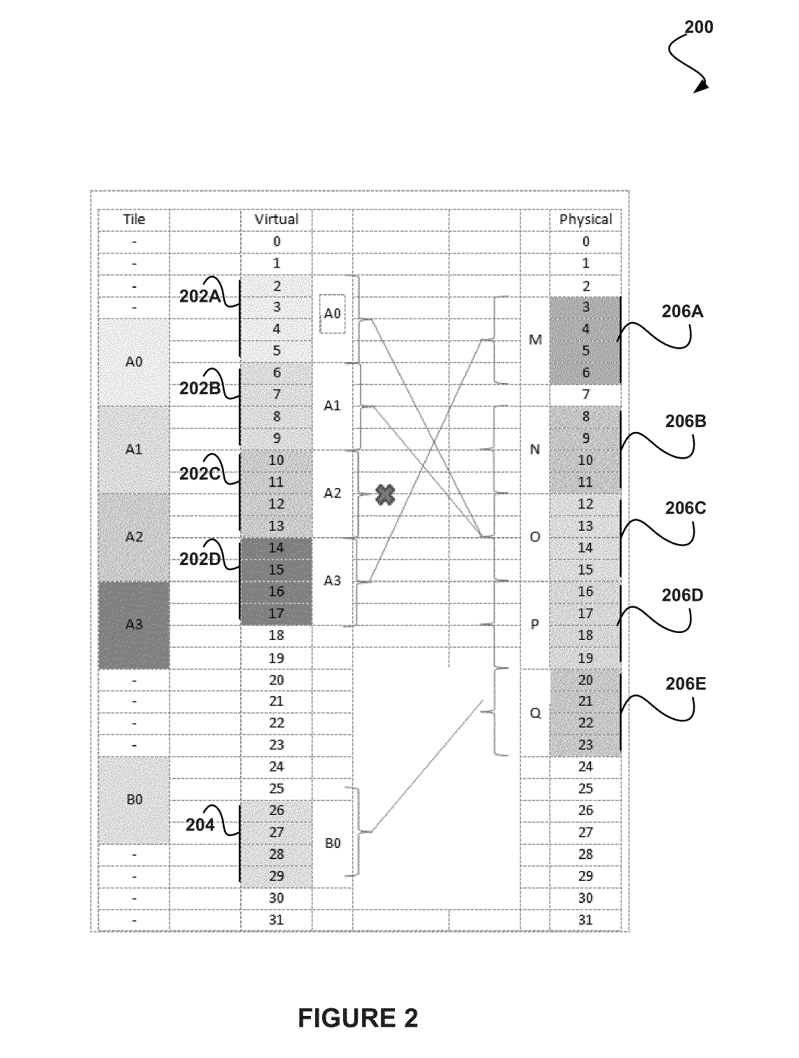

FIG. 2 shows an exemplary flexible mapping configuration 200, in accordance with another embodiment. As an option, the configuration 200 may be carried out in the context of the functionality of FIG. 1. Of course, however, the configuration 200 may be implemented in any desired environment. It should also be noted that the aforementioned definitions may apply during the present description.

As shown, a plurality of tiles 202A, 202B, and 202D belonging to a first texture and tiles 204 belonging to a second texture are mapped to a plurality of physical pages 206A-E. Specifically, virtual tiles 202A and 202B are mapped to physical page 206C, which demonstrates that multiple tiles may refer to a single physical page. Additionally, virtual tile 202D is mapped to physical page 206A, and virtual tile 204 is mapped to physical page 206C, which demonstrates that the association between virtual tiles and physical pages may be arbitrarily reordered and does not have to be continuous and contiguous. This also demonstrates that virtual tiles may be mapped to physical pages that are distinct from other physical pages mapped to other virtual tiles in a texture.

Further, virtual tile 202C is not mapped to any physical page and therefore has no memory associated with it. In one embodiment, one or more virtual tiles may be mapped to one or more physical locations using a page table with a plurality of page table entries. For example, the page table may contain entries that each include a physical address where a tile's data resides.

Texture tiling may include a mechanism to create large texture surfaces without dedicating the physical memory for the entire surface. In one embodiment, the texture may be broken up into discrete tiles in a regular grid (e.g., for 2D textures, etc.). In another embodiment, each tile may or may not be resident in memory and the mapping from a tile to a memory location may be controlled by the application.

Additionally, in one embodiment, the indirection from a tile to memory location may be done using the GPU's MMU to map virtual to physical address (by not using virtual to fully contiguous physical mapping). In another embodiment, when an application requests that a tile reference different physical pages, the driver may initiate a page table update.

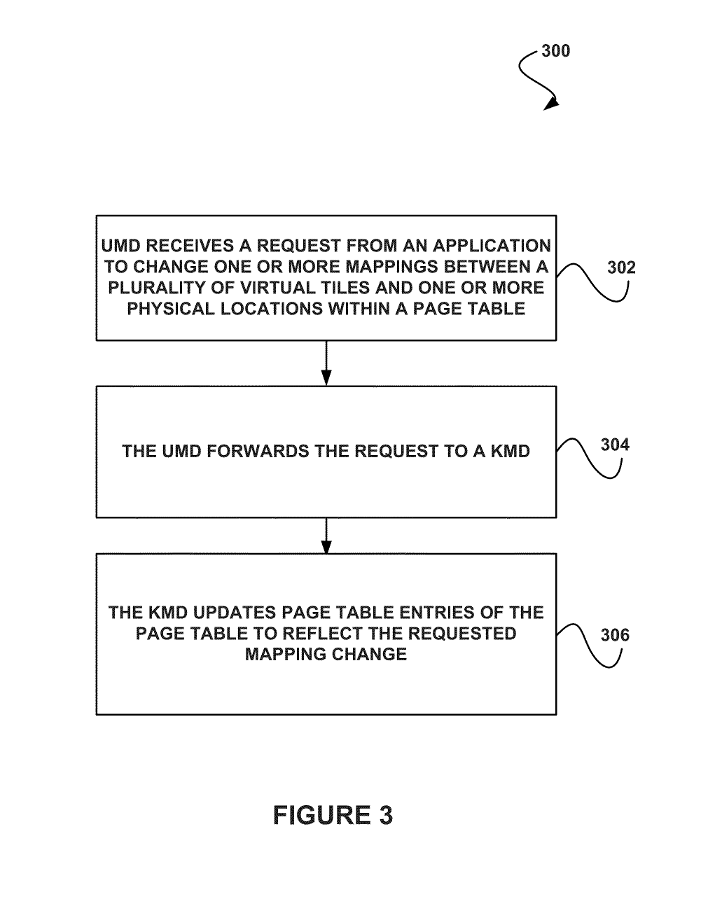

FIG. 3 shows a method 300 for updating mappings using a CPU driven solution, in accordance with another embodiment. As an option, the method 300 may be carried out in the context of the functionality of FIGS. 1-2. Of course, however, the method 300 may be implemented in any desired environment. It should also be noted that the aforementioned definitions may apply during the present description.

As shown in operation 302, a UMD receives a request from an application to change one or more mappings between a plurality of virtual tiles and one or more physical locations within a page table. In one embodiment, the request may include an indication of a change to a tile mapping. Additionally, as shown in operation 304, the UMD forwards the request to a KMD. Further, as shown in operation 306, the KMD updates page table entries of the page table to reflect the requested mapping change.

In this way, changes to tile mappings may result in the changing of virtual to physical mappings within the page table. GPUs may not have a tiled specific layer to implement this redirection, so the redirection may be performed using an existing virtual memory architecture. This may entail updating one or more addresses in the page table for the virtual memory associated with each tile when the application requests a tile mapping change.

Additionally, in one embodiment, the tile mappings may be managed by the application and UMD, but the PTE contents may be managed by the KMD. In this way, a user mode component may not directly manipulate the PTEs. In another embodiment, for the KMD to perform the PTE updates, the user mode driver may forward the mapping update requests to the KMD. The KMD may then write the PTEs with the updated mappings. The KMD may be aware of physical locations (i.e. that a tile resides in a predetermined range of pages), is considered to be secure, and can validate against malicious or otherwise erroneous mapping requests.

Further, in one embodiment, with GPU virtual memory, the user mode component (user mode driver—UMD) may be provided with a GPU virtual address that is able to use freely without regard for where the backing physical memory is located, or if its even resident at any given time. The kernel mode component (kernel mode driver—KMD) may be, at the same time, free to adjust the page table entries (PTEs) for the virtual addresses corresponding to various allocations to address the current location of the physical pages (or invalid of the allocation has been evicted).

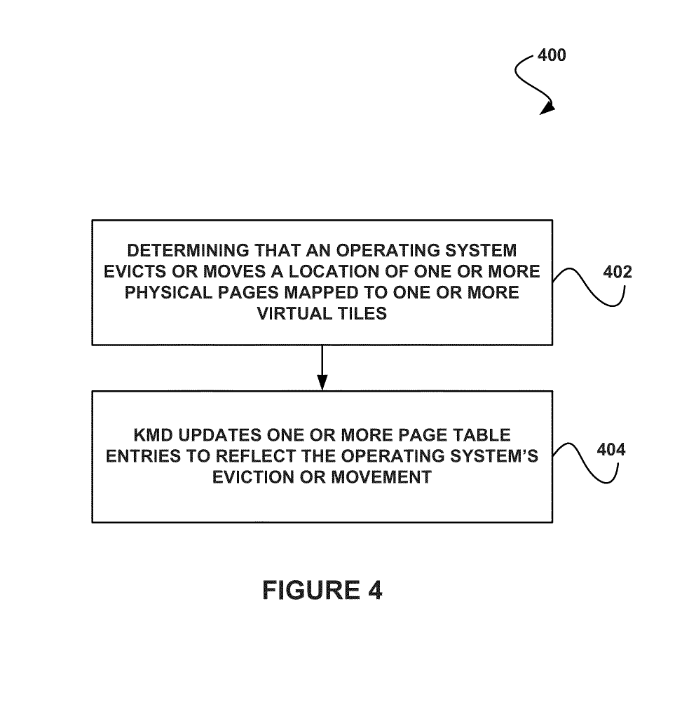

FIG. 4 shows a method 400 for responding to a location eviction or movement using a CPU driven solution, in accordance with another embodiment. As an option, the method 400 may be carried out in the context of the functionality of FIGS. 1-3. Of course, however, the method 400 may be implemented in any desired environment. It should also be noted that the aforementioned definitions may apply during the present description.

As shown in operation 402, it is determined that an operating system evicts or moves a location of one or more physical pages mapped to one or more virtual tiles. Additionally, as shown in operation 404, the KMD updates one or more page table entries to reflect the operating system's eviction or movement. In one embodiment, one or more page table entries may be invalidated by the KMD. In another embodiment, one or more page table entries may be updated to reference a new location. In yet another embodiment, the updating may be performed by the KMD maintaining a reverse mapping of physical pages to virtual tiles that reference each physical page. In still another embodiment, the updating may be performed by scanning one or more virtual mappings for references to the physical pages (being moved or evicted) to be updated.

In another embodiment, the CPU itself may write the page table entries using a KMD controlled and initiated compute shader invocation. For example, the compute shader invocation may be interleaved and serialized with the other application initiated rendering operations, the KMD may feed validation parameters into the compute shader to prevent malicious mapping requests. Additionally, the CPU may read/write many more page table entries at a given time than the CPU, which may be useful for scanning the virtual tile space when evicting/moving the physical memory. In another embodiment, the CPU access to the page table entry storage may be restricted to a CPU virtual address which exists only in a KMD controlled context.

Table 1 illustrates exemplary CPU side code for the operation updating page table entries from a request from an application to update tile mappings, in accordance with one embodiment. Of course, it should be noted that the exemplary code shown in Table 1 is set forth for illustrative purposes only, and thus should not be construed as limiting in any manner.

```
TABLE 1
struct PHYSICAL_TILE_POOL
{
    uint64 Address; //Physical address base (cell value of 3 in
Fig 2, 206A)
    uint64 Size; //Number of bytes allowed to be mapped (4
[cells 3 through 6] in Fig 2, 206A)
};
struct VIRTUAL_TILE_UPDATE
{
    uint TeleIndex; //Virtual tile for which the mapping is to be
changed (cell value 14 in Fig 2, 202D)
    uint PhysTilePoolIndex; //Which physical allocation to map to
    uint PhysTileIndex; //Which physical tile within the
allocation (values 0 for mapping of 14 Fig 2, 202D to 3 in Fig 2,
206A)
};
static const uint TILE_SIZE = 65536;
//Low level routine to write the PTE with the new address
void UpdatePte (uint64 PteAddressBase, uint PteIndex, uint64
Address);
void UpdateError( ); //Error routine for invalid/malicous inputs
void UpdateTileMappings
(
    uint64 PteAddressBase //Start location of PTEs to update
    uint PteCount, //Number of PTEs allowed (i.e. size of virtual
address)
    PHYSICAL_TILE_POOL* PhysTilePools //Physical allocations
    uint PhysTilePoolCount, //Number of physical allocations
    VIRTUAL_TILE_UPDATE* VirtualTileUpdates; //Virtual mapping
updates
    uint VirtTileUpdateCount //Number of virtual mapping updates
)
{
    for (uint i = 0; i < VirtTileUpdateCount; ++i)
    {
      //Validate address to update
      uint PteUpdateIndex = VirtualTileUpdates[i].TileIndex;
      if (PteUpdateIndex >= PteCount)
      {
        UpdateError( );
        break;
      }
      //Validate phycical allocation index
      uint PhysTileindex =
VirtualTileUpdates[i].PhysTilePoolIndex
      if (PhysTileindex >= PhysTilePoolCount)
      {
        UpdateError( );
        break;
      }
      //Validate relative physical offset against physical
allocation size
      uint64 PhysOffset = PhysTileIndex * TILE_SIZE;;
      if (PhysOffset >= PhysTilePools[PhysTileIndext].Size)
      {
        UpdateError( );
        break;
      }
      //All validation succeeded - commit PTE with new mapping
      PhysOffset += PhysTilePools [PhysTileIndex].Address;
      UpdatePte(PteAddressBase, PteUpdateIndex, PhysOffset);
  }
}
```

In one embodiment, the inputs to the above code may include a page table entry address for the base of the virtual address that will be updated and the number of page table entries. This may be provided by the KMD. In another embodiment, the inputs may include an array of physical allocations addresses and sizes. For example, the page table entries may be updated with values relative to the array. In yet another embodiment, the length of the array may be limited by the number of physical tile pools that have been created. This may be provided by the KMD. In still another embodiment, the inputs may include an array of type struct of virtual tile pools to update. The struct array may contain the virtual tile to update and the physical tile that virtual tile will reference. This may be provided by the UMD.

Additionally, one benefit of using GPU based operations may include the massively parallelizable nature of the above algorithm. For example, each iteration of the “for” loop may operate on an independent location and may need no state from other iterations. In one embodiment, the GPU may handle such (single instruction multiple data) SIMD operations extremely efficiently.

Further, in one embodiment, the GPU may also be used to handle an evict/move operation. For example, when the physical tile pool is moved, the GPU may scan the page table entries of the tiled resources to see if any of the tiles reference the tile pool being moved (this is a simple range check for a physically contiguous tile pool). If the tile is mapped to a tile pool being moved, the page table address may be updated to the new location. If the tile pool is being evicted (such that it's no longer accessible), the page table entry may be set to invalid (but the physical address may persist).

Further still, in one embodiment, the GPU approach may not require the KMD to maintain a list of mappings that are dependent on the physical location of the tile. In another embodiment, the GPU approach may not require the UMD to deliver these mappings on each and every change to the tile mappings. For example, instead of doing a precise targeted update of only the necessary pages, a brute force scan of the entire range may be done.

Also, in one embodiment, if a tile pool is evicted, the pre-eviction physical address of the tile pool may be stored in the KMD data structure for the tile pool allocation. The page table entries, while invalidated, may keep the pre-evict address. When the tile pool is brought back in, the same range check may be done with the old tile address (e.g., in the KMD data structure, etc.) to see which mappings need to be updated with the new tile pool's new address. In this way, the reverse page-to-tile mapping may not need to be maintained.

Table 2 illustrates exemplary page table scanning, in accordance with one embodiment. Of course, it should be noted that the exemplary scanning shown in Table 2 is set forth for illustrative purposes only, and thus should not be construed as limiting in any manner.

TABLE 2

```
//Returns 0 invalid page table entry (PTE)
uint64 GetPteAddress(uint64 PteAddressBase, uint PteIndex);
void HandleTilePoolMoveOrEvict
(
    uint64 PteAddressBase,
    uint PteCount,
    uint64 OldTilePoolAddress,
    uint64 OldTilePoolAddressLimit,
    uint64 NewPhysTilePoolBase
)
{
    for (uint i = 0; i < PteCount; ++i)
    {
      uint64 (PhysAddr = GetPteAddress(PteAddressBase, i);
      if (PhysAddr >= OldTilePoolAddress &&
        (PhysAddr <= OldTilePoolAddressLimit)
      {
        if (NewPhysTilePoolBase) //New addr != 0 means move
        {
          uint64 NewTileAddress = NewPhysTilePoolBase;
          NewTileAddress += PhysAddr - OldTilePoolAddress;
          UpdatePte(PteAddressBase, i, NewTile Address, true);
        }
        else //New addr == 0 mean invalidate
        {  //Keep the old address but invalidate the PTE
          UpdatePte(PteAddressBase, i, PhysAddr, false);
        }
      }
    }
}
```

In this way, graphics processing units (CPUs) may leverage virtual memory to obtain security, physical memory virtualization and a contiguous view of memory. Additionally, a more flexible association of graphics resources to memory may be enabled. Further, the UMD may be able freely associate virtual addresses of a rendering resource to arbitrary regions of an existing allocation (with the regions aligned to pages). Further still, the use of tiled textures may allow for an advanced page table entry update mechanism. Further still, the CPU may be used to perform page table updates through its high bandwidth access to the page table entries (e.g., as they may reside in video memory, etc.) and multiple simultaneous processors may perform multiple page table entry updates simultaneously.

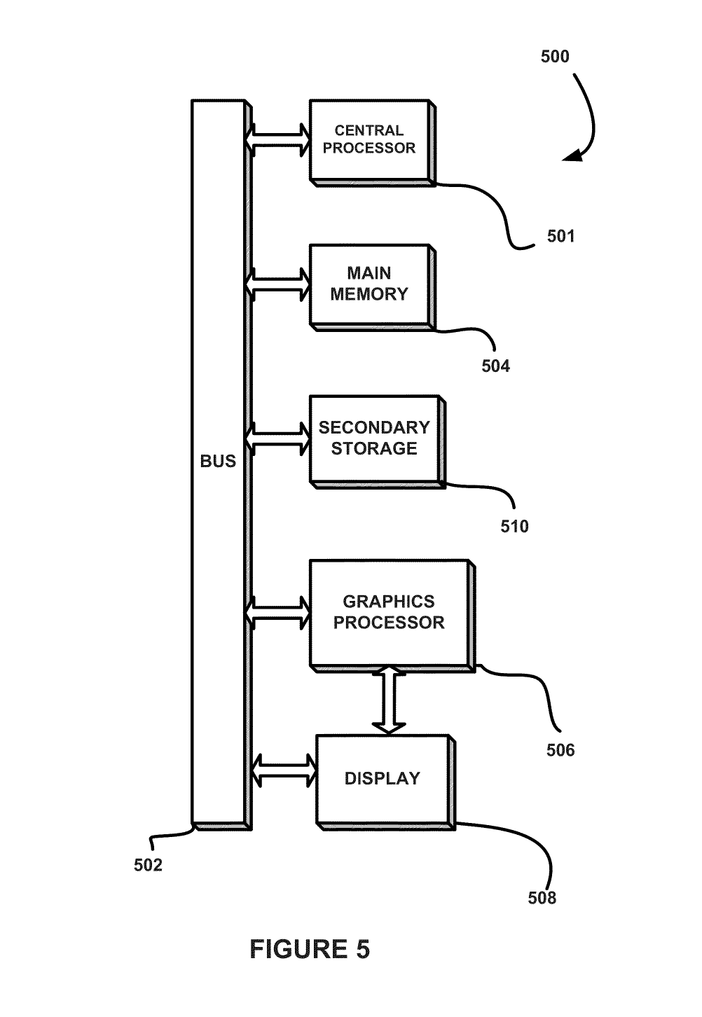

FIG. 5 illustrates an exemplary system 500 in which the various architecture and/or functionality of the various previous embodiments may be implemented. As shown, a system 500 is provided including at least one host processor 501 which is connected to a communication bus 502. The system 500 also includes a main memory 504. Control logic (software) and data are stored in the main memory 504 which may take the form of random access memory (RAM).

The system 500 also includes a graphics processor 506 and a display 508, i.e. a computer monitor. In one embodiment, the graphics processor 506 may include a plurality of shader modules, a rasterization module, etc. Each of the foregoing modules may even be situated on a single semiconductor platform to form a graphics processing unit (CPU). In another embodiment, the system 500 may include video DRAM. In yet another embodiment, the display may not be connected to the bus 502.

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user. The system may also be realized by reconfigurable logic which may include (but is not restricted to) field programmable gate arrays (FPGAs).

The system 500 may also include a secondary storage 510. The secondary storage 510 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 504 and/or the secondary storage 510. Such computer programs, when executed, enable the system 500 to perform various functions. Memory 504, storage 510, volatile or non-volatile storage, and/or any other type of storage are possible examples of non-transitory computer-readable media.

In one embodiment, the architecture and/or functionality of the various previous figures may be implemented in the context of the host processor 501, graphics processor 506, an integrated circuit (not shown) that is capable of at least a portion of the capabilities of both the host processor 501 and the graphics processor 506, a chipset (i.e. a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 500 may take the form of a desktop computer, laptop computer, and/or any other type of logic. Still yet, the system 500 may take the form of various other devices including, but not limited to a personal digital assistant (PDA) device, a mobile phone device, a television, etc.

Further, while not shown, the system 500 may be coupled to a network [e.g. a telecommunications network, local area network (LAN), wireless network, wide area network (WAN) such as the Internet, peer-to-peer network, cable network, etc.] for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
identifying a plurality of virtual tiles associated with a texture;
receiving a request to perform a mapping of the plurality of virtual tiles to one or more physical memory locations; and
mapping the plurality of virtual tiles to the one or more physical memory locations, utilizing a page table.

2. The method of claim 1, wherein the texture is divided up into the plurality of virtual tiles, such that each of the plurality of virtual tiles includes a portion of the texture.

3. The method of claim 1, wherein the request to perform the mapping is received from an application.

4. The method of claim 1, wherein the one or more physical memory locations include one or more physical pages in memory.

5. The method of claim 1, wherein the request is received by a user mode driver (UMD).

6. The method of claim 1, wherein the request includes a defined virtual address space.

7. The method of claim 1, wherein the request includes one or more addresses of the physical memory locations.

8. The method of claim 1, wherein the request indicates that multiple virtual tiles map to a single physical memory location.

9. The method of claim 1, wherein the request indicates that a virtual tile does not map to a physical memory location.

10. The method of claim 1, wherein the request indicates that a virtual tile maps to a physical memory location that is grouped separately from other physical memory locations that are mapped to other virtual tiles within the texture.

11. The method of claim 5, wherein mapping the plurality of tiles to the one or more physical memory locations includes passing the request to perform the mapping from the UMD to a kernel mode driver (KMD).

12. The method of claim 11, wherein the mapping of the plurality of tiles to the one or more physical memory locations is performed by the KMD.

13. The method of claim 1, wherein the page table stores the mapping between one or more virtual addresses and one or more physical addresses.

14. The method of claim 1, wherein the page table stores the mapping between one or more virtual addresses, where each virtual address represents a tile, and one or more physical addresses, where each physical address represents a physical memory location.

15. The method of claim 1, wherein the mapping between one or more virtual addresses and one or more physical addresses is not contiguous or continuous within the page table.

16. The method of claim 1, wherein the mapping is managed using a central processing unit (CPU)-driven solution.

17. The method of claim 1, wherein the mapping is managed using a graphics processing unit (GPU)-driven solution.

18. The method of claim 17, wherein managing the mapping using a graphics processing unit (GPU)-driven solution includes feeding validation parameters into a compute shader.

19. The method of claim 1, comprising:
determining an additional threshold value;
selecting an additional single dimension of the low discrepancy sequence;
for each element included within the low discrepancy sequence, simultaneously comparing the selected single dimension to the determined threshold value and comparing the selected additional single dimension to the determined additional threshold value; and
generating a subset of the low discrepancy sequence, based on the comparing.

20. A non-transitory computer-readable storage medium storing instructions that, when executed by a processor, cause the processor to perform steps comprising:
identifying a plurality of virtual tiles associated with a texture;
receiving a request to perform a mapping of the plurality of virtual tiles to one or more physical memory locations; and
mapping the plurality of virtual tiles to the one or more physical memory locations, utilizing a page table.

21. A system, comprising:
a processor for identifying a plurality of virtual tiles associated with a texture, receiving a request to perform a mapping of the plurality of virtual tiles to one or more physical memory locations, and mapping the plurality of virtual tiles to the one or more physical memory locations, utilizing a page table.
